(19) United States
(12) Patent Application Publication
(10) Pub. No.: US 2018/0190250 A1
(43) Pub. Date: Jul. 5, 2018

(54) CONTROL SYSTEM FOR AUDIO PRODUCTION

(71) Applicant: ILIO Enterprises, LLC, Westlake Village, CA (US)

(72) Inventors: Mark David Hiskey, Malibu, CA (US); Eran Weinberg, Los Angeles, CA (US); Tamas Domonkos, II-Hemel (MT)

(21) Appl. No.: 15/858,225

(22) Filed: Dec. 29, 2017

Related U.S. Application Data
(60) Provisional application No. 62/440,895, filed on Dec. 30, 2016.

(51) Int. Cl. G10H 1/00; G06F 3/041; G06F 3/0488; G06F 3/0484

(52) U.S. Cl. CPC G10H 1/0025; G06F 3/0416; G06F 3/04883; G10H 2210/101; G06F 3/0412; G10H 2220/096; G06F 3/04847

(57) ABSTRACT

A touch control system comprising: a first electronic data processing device, a second electronic data processing device, and a tactile control surface, wherein the first electronic data processing device may be a computer, and the second electronic data processing device may be a tablet. The computer may comprise a DAW, first software application, and wrapped plug-ins. The tablet may comprise a second software application.

### CROSS REFERENCE PARAGRAPH

This U.S. Non-Provisional Patent Application No. claims the benefit of and priority to U.S. Provisional Patent Application No. 62/440,895, filed on Dec. 30, 2016, titled “Control System For Audio Production”, by co-inventors Mark Hiskey and Eran Weinberg, the contents of which are expressly incorporated herein by this reference and to which priority is claimed.

### FIELD OF USE

The present disclosure generally relates to the field of creative production software control solutions. More specifically, the present disclosure generally relates to a system for providing universal, reliable, and repeatable tactile control of software, namely plug-ins, using a hardware device.

### BACKGROUND

Modern music producers often create music on a computer using a Digital Audio Workstation (“DAW”). The benefits of DAWs are numerous, but chief among them are excellent sound quality for a moderate price, instant storage and retrieval, portability via file sharing, nearly limitless tracks and expandability depending on the power of the host computer, boundless creativity due to the variety and quality of plug-ins that are available, and the ability to record, re-record, edit and mix music easily and non-destructively.

Most DAWs support the use of plug-ins, which enhance the power of a DAW by providing creative and varied options for music creation. Plug-ins are typically developed by 3rd party developers separately from DAW developers. Because plug-ins are developed by a multitude of independent developers, the parameter controls and interface conventions may vary widely from plug-in to plug-in. For example, some plug-ins provide access to parameter settings via external MIDI control and others do not, or some utilize keyboard data entry while others do not. There is very little consistency in user-interfaces from plug-in to plug-in, and they often require the user to “hunt and peck” with a computer mouse to learn and relearn functions.

In addition, the computer mouse is often not the optimal device for interfacing with plug-ins. Most plug-ins have attractive designs that are visually analogous to the hardware devices they emulate. For example, a compressor plug-in interface may be designed with stylized black knobs, old voltage meters and a brushed steel surface to closely resemble a desirable vintage hardware compressor. A virtual synthesizer may have the exact same knob and slider design as its corresponding real-world version, or it may have a non-derivative modern design with glassy graphic elements, and so on. Developers apply significant thought and resources to GUI design as a way of differentiating their products and as an indicator of the quality of sound their plug-ins can create. Using a mouse to adjust the parameters of these plug-ins is counter-intuitive. Typically, users must adjust a parameter by clicking on a virtual knob on the interface and dragging the mouse up or down along the y axis that bisects the knob. At best, this is unsatisfying as there may be no correlation between the vertical movement of the mouse and the rotary action of the knob. In addition, some parameters are very small graphically, while others require drawing, and in both cases manipulating them can be difficult using a mouse.

Recognizing the market preference for hands-on control, the music products industry has created a number of hardware MIDI controllers intended to provide tactile control of software. These controllers typically include rotary knobs, sliders, and buttons that may be assigned to software parameters via the MIDI protocol. They tend to fall short of expectations for a variety of reasons. One reason is that when a hardware control does not correlate intuitively with a software control, the user experiences a cognitive disconnect that results in a workflow disruption.

Some controller manufacturers have attempted to meet this challenge by labeling the controls with small LED or LCD screens, wherein the display on the screens can change depending on the software or parameter controlled. While this solution helps to identify the correct control, it requires that the user repeatedly shift attention from the computer screen to the controller surface and back again. In optimal conditions, the computer screen may be one or two feet away from the controller requiring the user to continually move his or her head and refocus, which is another significant workflow disruption.

Users may elect to use a second computer screen or tablet computer functioning as a second screen to display plug-in interfaces. Such use requires the user to physically “click and drag” the plug-in interface to the second screen and resize the interface for optimal resolution using mouse control.

Additionally, because current plug-ins are created by hundreds of different developers, each with different methods of assigning external control, or in many cases no external control at all, there is a vast discrepancy in the way physical controls are assigned to software parameters, and in many cases those assignments simply cannot be made. Often, the user must re-assign parameters to controls as these assignments are saved within one track or session and not within the plug-in itself. Due to these challenges, the user often forgoes using physical controls in favor of using a mouse, even though the mouse is not optimal.

Another challenge concerns plug-in management. With many thousands of plug-ins available on the market, a single user may have a hundred or more plug-ins installed in his system. Further, plug-ins fall under a number of different use categories, such as compressor, EQ, reverb, synthesizer, drum loops, orchestral, and so on. The categorization of plug-ins is not well-developed in most DAWs and the user must recall from memory what a given plug-in's function is. As a result, the user often resorts to using a small number of installed plug-ins because he or she simply cannot remember what all of them do. Also, in any given project, a user may have as many as 50 plug-ins in use at one time, often with several instances of one plug-in spread across many tracks. With so many open plug-ins, it is very difficult to know intuitively which plug-in is assigned to which track. Many users have a second monitor on their computer systems to display their plug-in windows on a dedicated screen. This may help keep plug-in interfaces from obscuring the DAW interface, but the problem of navigating dozens of plug-in windows remains. Accessing a certain plug-in's controls may be akin to finding a needle in a haystack, particularly in a large, complicated project.

Accordingly, what is needed is a system that does not: dissociate the linear vertical movement of the mouse and rotary movement of software knobs; dissociate physical controllers and software controls; result in workflow disruption due to extraneous head movement and refocusing; cause the user to “click and drag” the plug-in interface to a second screen; require inconsistent (or non-existent) methods of assigning physical controls to software parameters; or cause difficulty in managing the use of and having quick access to plug-ins.

### SUMMARY

The present specification discloses a system for providing universal, reliable, and repeatable tactile control of software using a hardware device.

One embodiment may be a touch control audio interface system comprising: a first electronic data processing device; a second electronic data processing device; and a tactile control surface; wherein the first electronic data processing device may comprise an input device, a first software application, and a first electronic data processing device display; wherein the first electronic data processing device may comprise a digital audio workstation; wherein one or more audio plug-ins may be used in conjunction with in the digital audio workstation, such that the one or more audio plug-ins are accessible via use of the digital audio workstation; wherein the digital audio workstation may comprise digital representations of analog audio mixing controls; wherein the digital audio workstation may comprise multiple digital audio tracks; wherein the digital audio workstation may comprise an audio editing software interface for editing the audio tracks; wherein the one or more plug-ins may apply signal processing to the digital audio tracks; wherein the one or more plug-ins may be sound sources within the digital audio tracks; wherein the one or more plug-ins may comprise an audio editing software interface for editing the plug-ins; wherein the first software application may manage communication between the one or more plug-ins and the second electronic data processing device; wherein the first software application may manage communication between the one or more plug-ins and the tactile control surface; wherein the second electronic data processing device may comprise a second software application and second electronic data processing device display; wherein the second software application may be in electronic communication with the first software application; wherein the first software application my be in electronic communication with the one or more plug-ins; wherein the tactile control surface may be in electronic communication with the first software application; wherein the tactile control surface may be in electronic communication with the one or more plug-ins; wherein the second software application may display the one or more audio plug-ins on a display of the second electronic data processing device; wherein the second software application may allow for selection of the one or more audio plug-ins via the second electronic data processing device; wherein selecting the one or more audio plug-ins on the second electronic data processing device may display the one or more audio plug-ins; wherein the tactile control surface may comprise physical input mechanisms; wherein the physical input mechanisms may comprise assignable tactile interfaces; wherein one or more of the physical input mechanisms may be configured to be assignable to portions of the one or more plug-in interfaces; and wherein one or more of the physical input mechanisms may be configured to be assignable to portions of digital representations of analog audio editing controls. The physical input mechanisms may comprise rotary knobs, push buttons, switches, and touch sliders. The tactile control surface may comprise a free wheel, which may allow tactile control of portions of the one or more plug-in interfaces, or tactile control of portions of digital representations of analog audio mixing controls, but which may not be assignable. The input mechanisms may comprise a learn mechanism. One or more of the physical input mechanisms may be configured to be assignable to portions of the one or more plug-in interface editing controls, or to portions of the digital representations of analog audio mixing controls through use of the learn mechanism. The physical input mechanisms may comprise indicators that the one or more of the physical input mechanisms are assigned to portions of the one or more plug-in interface editing controls, or to portions of the digital representations of analog audio mixing controls. The assignments of the physical input mechanisms to portions of the one or more plug-in interface editing controls, or to digital representations of analog audio mixing controls may be saved to a profile and are loadable when the one or more audio plug-ins are active. The tactile control surface may not be connected to the digital audio workstation via a MIDI controller protocol. The second electronic data processing device may be a tablet. The second electronic data processing device display may be located near the tactile control surface. The second electronic data processing device may be in electronic communication with the first electronic data processing device via a wireless connection. The second electronic data processing device may be in electronic communication with the first electronic data processing device via a wired connection. The tactile control surface may be in electronic communication with the first electronic data processing device via a wired connection.

Another embodiment may be a method of editing digital audio, the steps comprising: providing a tactile control surface; providing a first software application configured to run on a first electronic data processing device; providing a second software application configured to run on a second electronic data processing device; wherein the first software application may be in communication with one or more plug-ins; wherein the second software application may be in electronic communication with the first software application; wherein the tactile control surface may be in electronic communication with the first software application; engaging a learn function by pressing a physical learn button of the tactile control surface; selecting a digital representation of an analog audio editing control displayed on the second electronic data processing device; assigning a physical input mechanism to the selected digital representation of an analog audio editing control; and disengaging the learn function by pressing the physical learn button of the tactile control surface. The digital representation of an analog audio editing control displayed on the second electronic data processing device may be similar in appearance to the physical input mechanism.

Another embodiment may be a touch control audio interface system comprising: a first electronic data processing device; a second electronic data processing device; and a tactile control surface; wherein the first electronic data processing device may comprise an input device, a first software application and first electronic data processing device display; wherein the first electronic data processing device may comprise a digital audio workstation; wherein one or more audio plug-ins may be used in conjunction with in the digital audio workstation, such that the one or more audio plug-ins are accessible via use of the digital audio workstation; wherein the digital audio workstation may comprise digital representations of analog audio mixing controls; wherein the digital audio workstation may comprise multiple digital audio tracks; wherein the digital audio workstation may comprise an audio editing software interface for editing the audio tracks; wherein the one or more plug-ins may apply signal processing to the digital audio tracks; wherein the one or more plug-ins may be sound sources within the digital audio tracks; wherein the one or more plug-ins may comprise an audio editing software interface for editing the plug-ins; wherein the first software application may manage communication between the one or more plug-ins and the second electronic data processing device; wherein the first software application may manage communication between the one or more plug-ins and the tactile control surface; wherein the second electronic data processing device may comprise a second software application and second electronic data processing device display; wherein the second software application may be in electronic communication with first software application; wherein the first software application may be in communication with the one or more plug-ins; wherein the tactile control surface may be in electronic communication with the first software application; wherein the tactile control surface may be in electronic communication with the one or more plug-ins; wherein the second software application may display the one or more audio plug-ins on a display of the second electronic data processing device; wherein the second software application may allow for selection of the one or more audio plug-ins via the second electronic data processing device; wherein selecting the one or more audio plug-ins on the second electronic data processing device may display the one or more audio plug-ins; wherein the tactile control surface may comprise physical input mechanisms; wherein the physical input mechanisms may comprise assignable tactile interfaces; wherein one or more of the physical input mechanisms may be configured to be assignable to portions of the digital representations of analog audio editing controls; wherein the physical input mechanisms may comprise rotary knobs, push buttons, switches, and touch sliders; wherein the tactile control surface may comprise a free wheel; wherein the input mechanisms may comprise a learn mechanism; wherein one or more of the physical input mechanisms may be configured to be assignable to portions of the digital representations of analog audio editing controls through use of the learn mechanism; wherein the physical input mechanisms may comprise indicators that the one or more of the physical input mechanisms are assigned to portions of the digital representations of analog audio editing controls; wherein the assignments of the physical input mechanisms to digital representations of analog audio editing controls may be saved to a profile and are loadable when the one or more audio plug-ins are active; wherein the second electronic data processing device may be a tablet; wherein the second electronic data processing device display may be located near the tactile control surface; wherein the tactile control surface may be in electronic communication with the first software application; and wherein the tactile control surface may be in electronic communication with the first electronic data processing device via a wired connection.

In operation, a Touch Control System (“TCS”) may be installed for use on a computer system. The TCS may be installed by: 1) connecting a tactile control surface of the TCS to a first computer via USB; 2) downloading and installing a first associated TCS Application on a first computer, 3) downloading and installing a second associated TCS Application on a second computer, or more preferably, a touch screen enabled device; 4) connecting the first computer to a second computer, preferably via WiFi or USB through the connected Control Surface; 5) installing Plug-in Wrapper software on the first computer; and 5) opening the Plug-in Wrapper software, and selecting plug-ins to “wrap” for use with the TCS.

In one embodiment, while creating music in a DAW, a user may create a new track and instantiate a plug-in virtual instrument. Once a plug-in instrument interface appears on the computer screen, it may also be available at the optimal position and resolution on the TCS Application on the second computer. When the second computer is a touch enabled device, the touch enabled device may be angled horizontally on a stand behind the Control Surface. The user may now focus his attention on the plug-in virtual instrument interface on the second computer. For example, if the user would like to adjust the filter cutoff frequency of a plug-in instrument, the user may touch the corresponding Parameter control on the second computer touch screen. Rather than shifting focus to a mouse in order to adjust the Parameter, the user may turn a large “free wheel” on the Control Surface to dial in the value desired. (This is the “Tap and Turn” functionality that will be explained in more detail below.) Now the user may freely edit and experiment with all parameters of the instrument, enjoying tactile feedback, and working quickly without having to refer to the first computer screen or remembering controller assignments. As the user continues editing the instrument, the user may then decide to assign additional Parameters to certain controls on the Control Surface. This may be done easily with a dedicated “Learn” button on the Control Surface. These assignments may be saved to the wrapped plug-in and may be recalled any time that wrapped plug-in is instantiated in a project.

Additionally, as a user continues working and adding wrapped plug-ins to the production, the second TCS Application may display every wrapped plug-in that is called into service on the first computer. When the user would like to return to the interface of a previously instantiated plug-in, he may call up a thumbnail view in the second TCS Application, visually reference which plug-in to edit by image and/or track name, tap the thumbnail and begin editing.

As a summary, one embodiment of using the TCS may comprise: opening the DAW; launching the TCS Application on the second computer; creating a Track and instantiating the wrapped version of the plug-in; editing the plug-in using the second TCS Application and the Control Surface; and switching to different plug-ins using the thumbnail view of the second TCS Application.

The term “Tap and Turn” describes the action of selecting a Parameter on the second computer's TCS Application and turning a knob on the Control Surface to make quick adjustments to the Parameter value. This action is fast, intuitive, and efficient because there may be an immediate connection between the Parameter and the control input (knob, slider, switch, or button). While the Control Surface features a large “Free Wheel” which is adapted to this function, any unassigned control input on the hardware is capable of changing the value of the last-chosen Parameter on the wrapped plug-in.

Alternatively, if the user would like to permanently assign a Parameter to one of the assignable knobs, buttons, or touch slider, the user may select the Parameter on the first computer or the second computer, press the “Learn” button on the Control Surface, then press one of the control inputs on the hardware to save the assignment. That control input assignment may remain in effect for that wrapped plug-in, regardless of the DAW or project it is being used in, until the user reassigns the control input to another Parameter in the plug-in.

The TCS may provide a consistent, intuitive method to assign controls to any plug-in, even if the plug-in does not support MIDI input, by potentially bypassing MIDI, enabling a more direct connection between the control input and the Parameter, and plug-ins that do not support MIDI learn can be assigned to hardware controls using the TCS. This may be done through standard USB Communications Device Class (“USB CDC”) communication protocols to enable a uniquely comprehensive connection between the hardware and software components.

In an embodiment, the TCS may create an external document in the system that stores the control input Parameter assignments with the wrapped plug-in. When a TCS user assigns the control input, the TCS may automatically save the assignments so the user does not need to do so. Every time the user opens the wrapped plug-in, whether it's within the current project or in a new project, the Control/Parameter assignments may be automatically loaded. This may save the user much time, confusion, and effort from having to re-assign the control input, and may provide a more consistent, reliable experience.

In one embodiment, the user may store and recall multiple groups of Control/Parameter assignments that may be loaded manually by the user into the active plug-in. This may allow the user flexibility by allowing multiple Control/Parameter assignment setups for one plug-in.

In one embodiment, the second software application may display control input assignments and Parameter values in a narrow horizontal strip at the bottom of the second computer display. This may be a quick reference that allows the user instant recognition of the control/parameter assignments for the current wrapped plug-in.

In one embodiment, a Display button on the Control Surface may display control input assignments and Parameter values in a pane that appears beneath the wrapped plug-in interface on the first computer display. This may be a quick reference that allows the user instant recognition of the control/parameter assignments for the current wrapped plug-in.

The close physical proximity of visual and tactile input may simulate working with actual hardware, and may result in a more satisfying, smooth and productive workflow.

The TCS may automatically display the plug-in interface at its optimal position and resolution on the second computer screen without the need for further manual adjustment by the user.

In the TCS, wrapped plug-ins may be viewed in a thumbnail grid format that is easy to filter and search. As the user adds plug-ins in the DAW, wrapped plug-in thumbnails may be displayed on the second computer. This may allow the user to easily browse and sort through the wrapped plug-ins and search for wrapped plug-ins by name and track. Beyond organizing the wrapped plug-ins, the user may quickly hide and launch wrapped plug-in windows with the touch of a button on the Control Surface.

The TCS may automatically record-enable the selected wrapped plug-in's track, and allow the user to assign a track name to the plug-in.

The steps for linking the wrapped plug-in to the track may comprise: 1) identifying the TCS by the DAW as a Mackie Controller, which uses an open source communication protocol for DAW controllers, to allow the TCS to gain access to the track names, and DAW control functions such as record, play, and other functions; and 2) identifying the track by capturing the plug-in window header. Because the TCS may have access to a wrapped plug-in window, the TCS is able to identify the window name and extract the track name. The TCS may then compare the track name from the header and the track name from the DAW list and establish a link. When a user activates a wrapped plug-in, the wrapped plug-in may automatically arm the track that it is assigned to. The user may disarm the track if the user desires.

TCS may be a system for providing universal, reliable, and repeatable tactile control of software using a hardware device coupled with a tablet display and utilizing network communications, custom software interpolation, screen capture, windows management and touch control.

TCS may be a plug-in management solution that improves music production workflow. TCS may simplify the way users manage and modify plug-ins.

These, as well as other components, steps, features, objects, benefits, and advantages, will now become clear from a review of the following detailed description of illustrative embodiments, and of the claim.

### BRIEF DESCRIPTION OF THE ILLUSTRATIVE EMBODIMENTS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

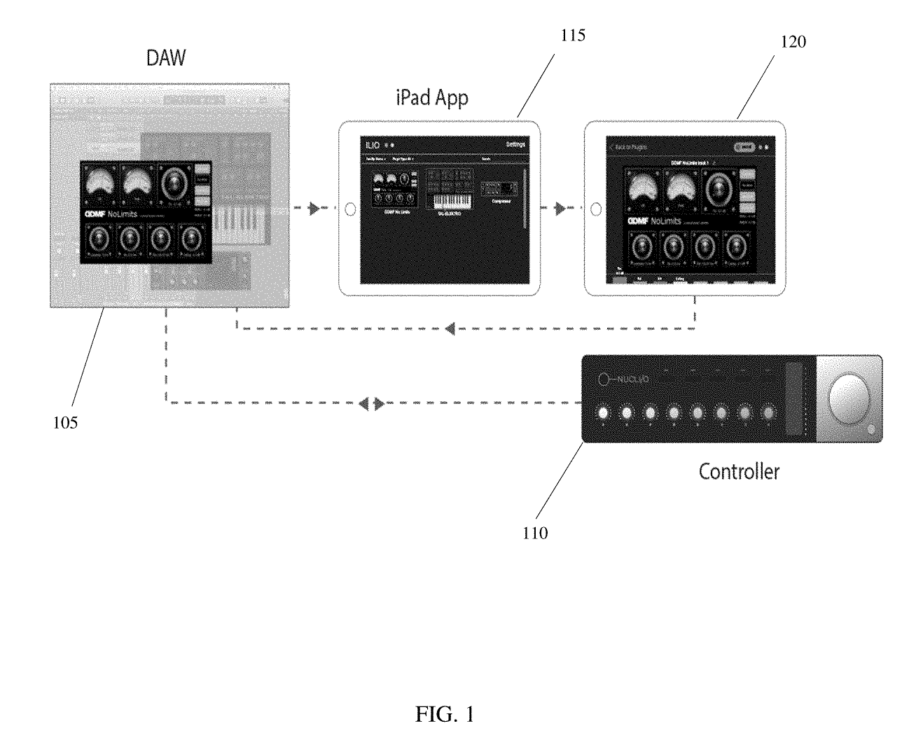

FIG. 1 is a diagram of one embodiment showing different components of the Touch Control System and how the different components interact.

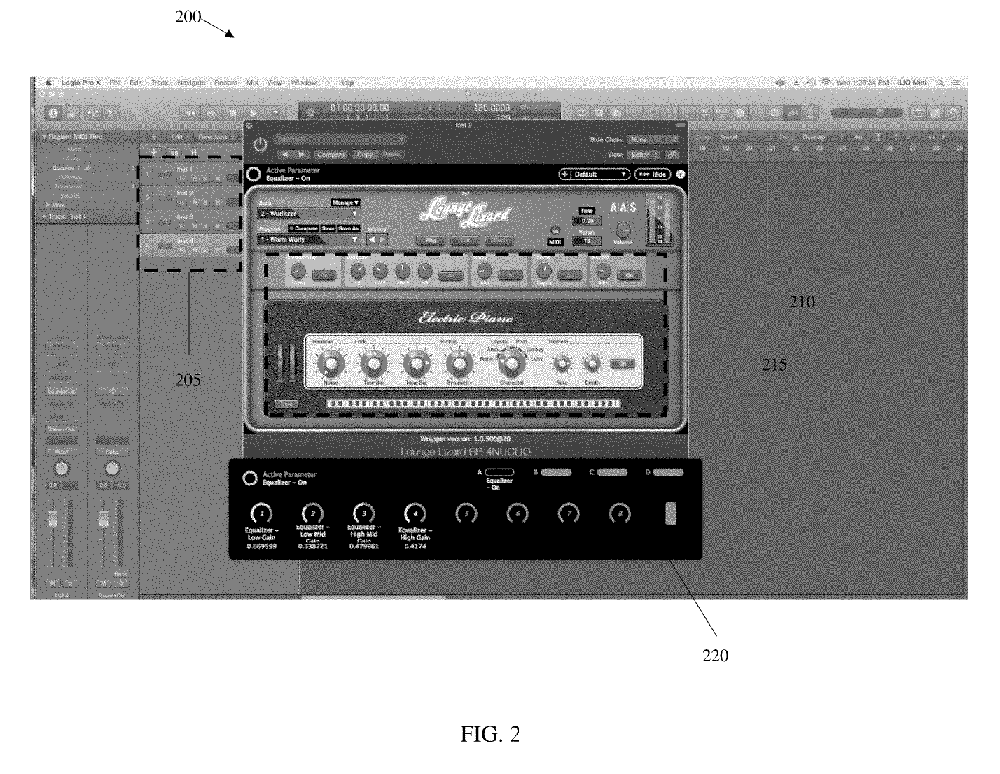

FIG. 2 is a screenshot of one embodiment of a DAW with an active plug-in.

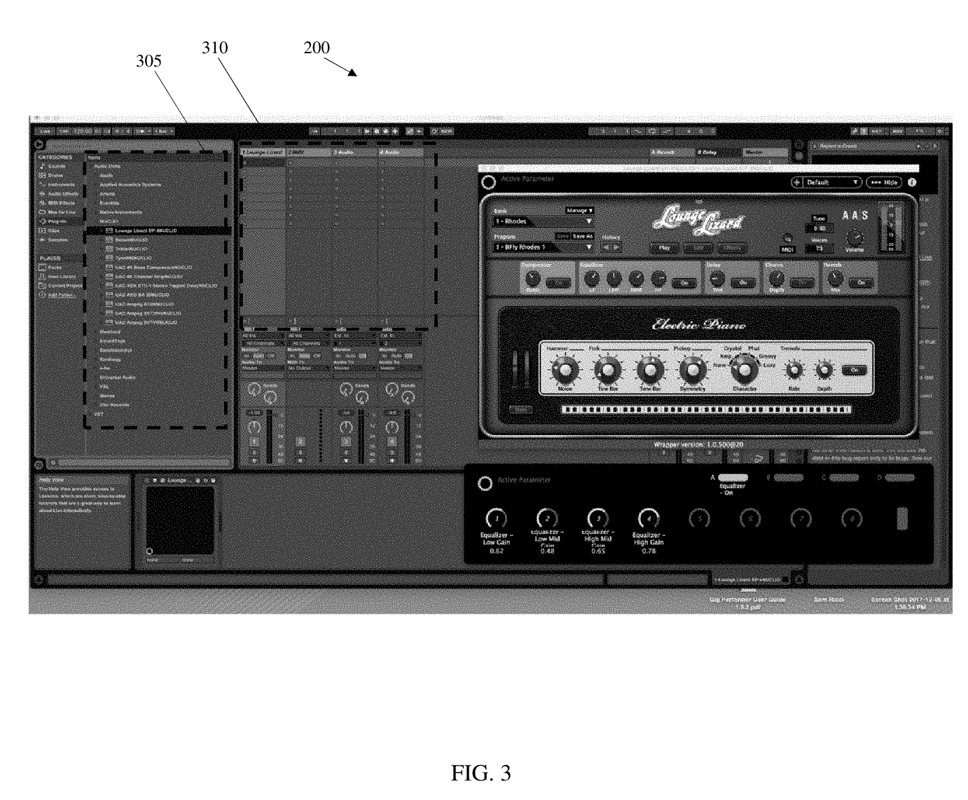

FIG. 3 is a screenshot of one embodiment of a DAW with a plug-in selection pane.

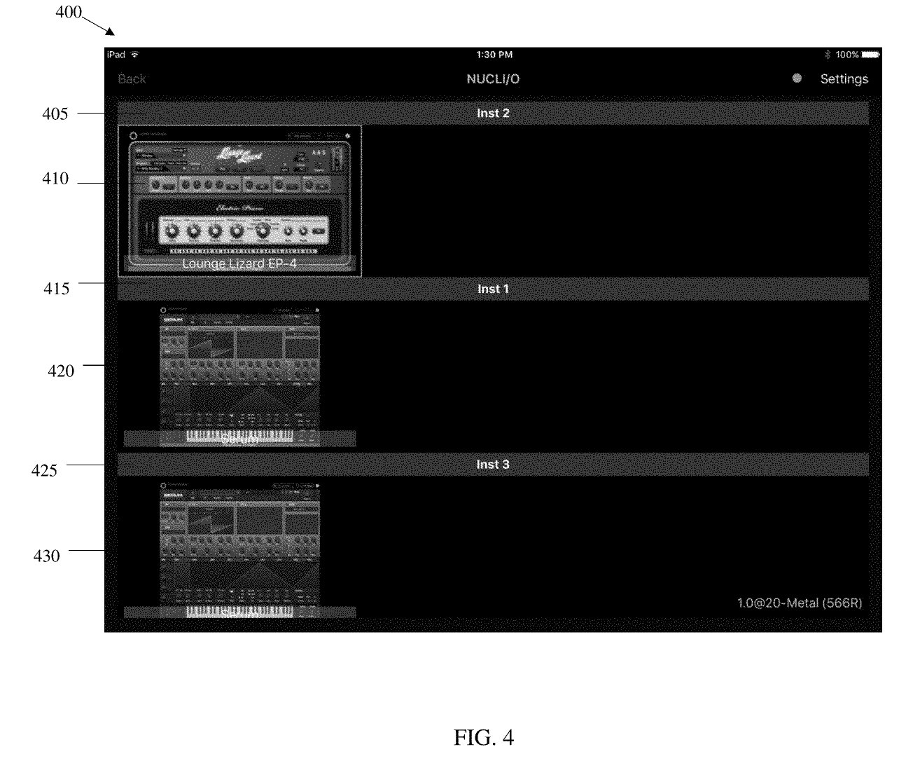

FIG. 4 is a screenshot of one embodiment of a plug-in selection screen on a tablet.

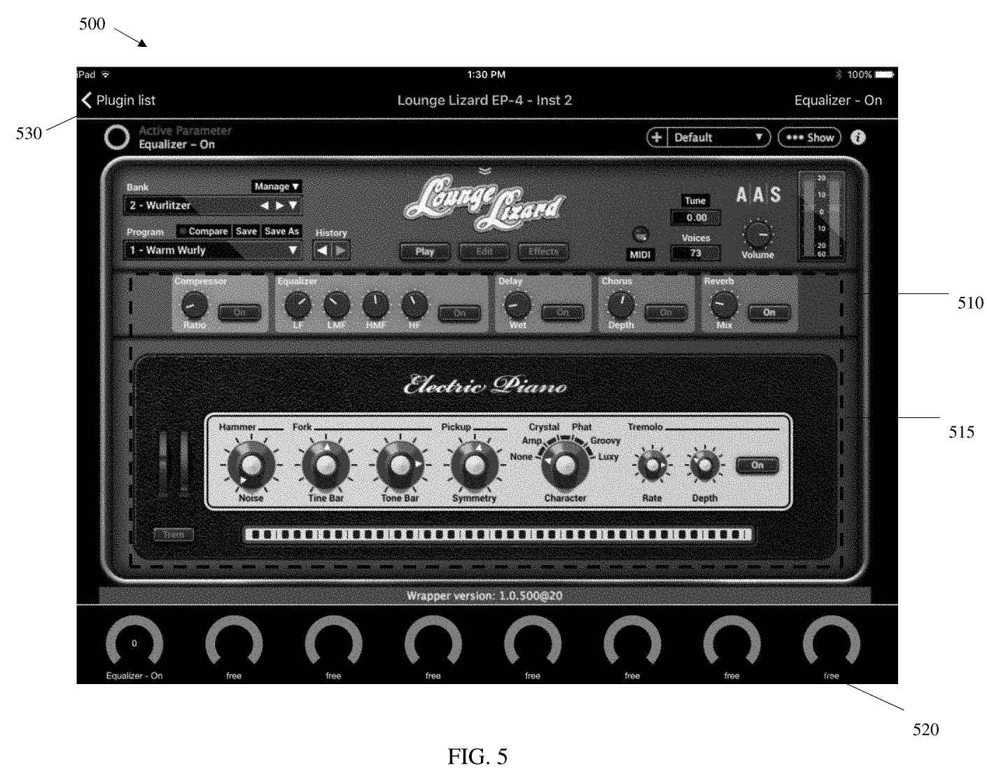

FIG. 5 is a screenshot of one embodiment of a selected plug-in on a tablet.

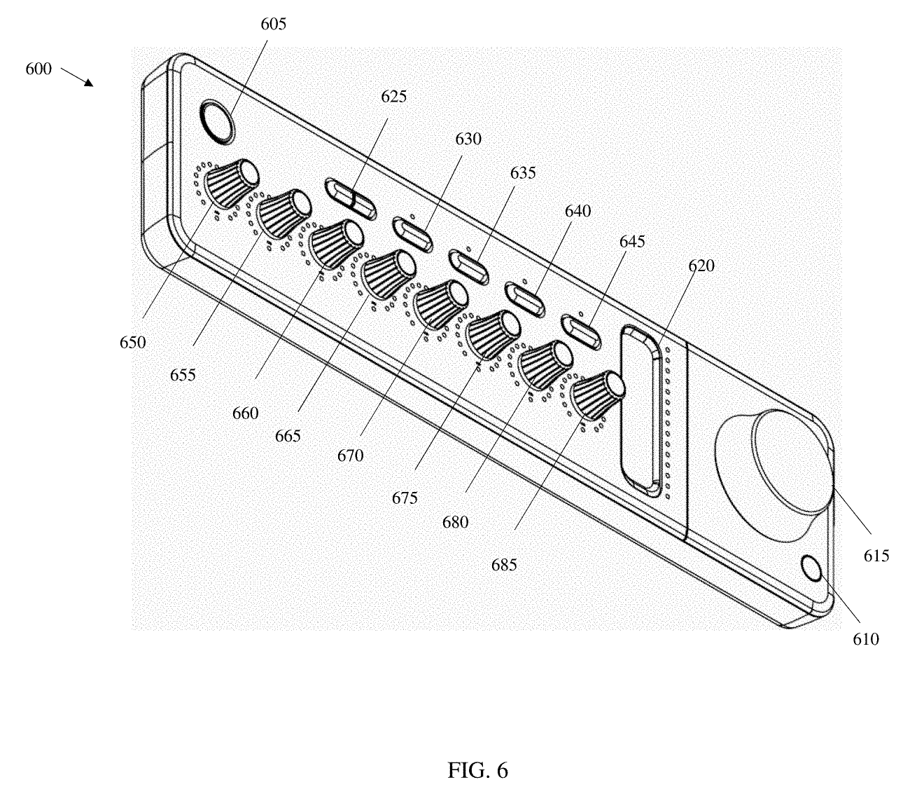

FIG. 6 is an illustration of one embodiment of a tactile control surface.

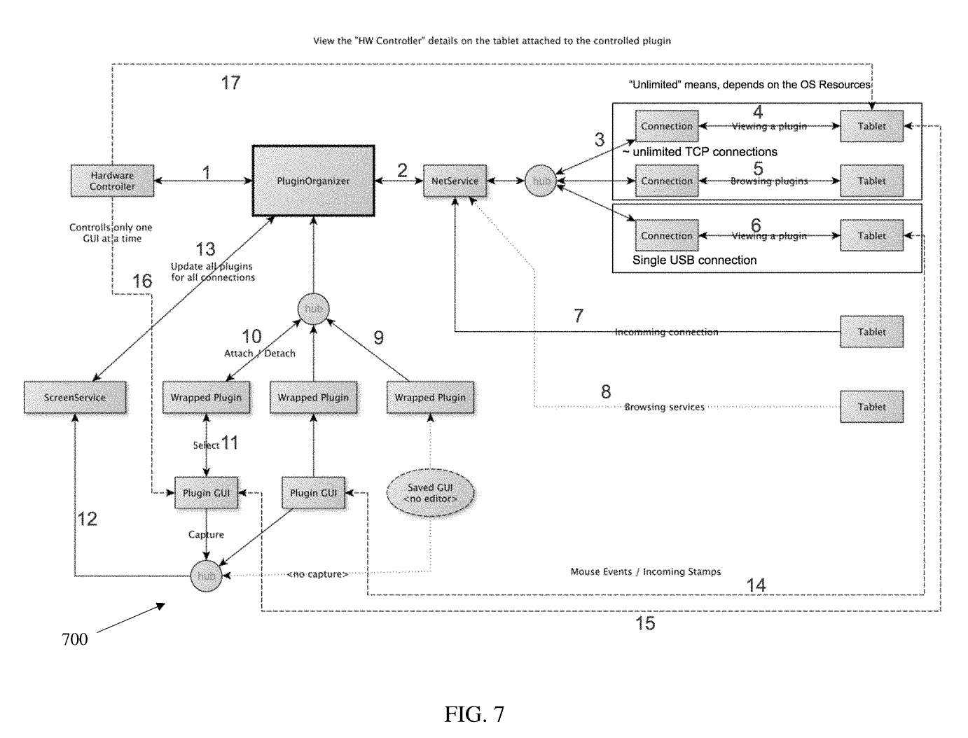

FIG. 7 is a flow diagram showing interactions between components of one embodiment of the tactile control system.

### DETAILED DESCRIPTION OF THE ILLUSTRATIVE EMBODIMENTS

In the following detailed description of various embodiments, numerous specific details are set forth in order to provide a thorough understanding of various aspects of one or more embodiments. However, one or more embodiments may be practiced without some or all of these specific details. In other instances, well-known procedures and/or components have not been described in detail so as not to unnecessarily obscure aspects of the embodiments.

While some embodiments are disclosed here, still other embodiments will become obvious to those skilled in the art as a result of the following detailed description of the illustrative embodiments. The embodiments are capable of modifications of various obvious aspects, all without departing from the spirit and scope of the protection. The figures, and their detailed descriptions, are to be regarded as illustrative in nature and not restrictive. Also, the reference or non-reference to a particular embodiment shall not be interpreted to limit the scope of protection.

### Definitions

Several terms of art are used herein, and one possible set of definitions are provided as follows.

Touch Control System (TCS): a system for providing universal, reliable, and repeatable tactile control of software using a hardware device and second computer that may be a mobile tablet device.

Tactile Control Surface (also known as Controller): The hardware device that is part of the TCS. The Tactile Control Surface may be of the appropriate size and shape to sit atop a music production desk, atop a controller keyboard, or on a work surface that is typical of a production studio. The Tactile Control Surface may comprise: one large “free wheel”; one or more, preferably eight, assignable knobs; one or more, preferably five, assignable push buttons; and one or more, preferably one, assignable touch slider. Additionally, there may be one or more dedicated “Learn” buttons and one or more dedicated “Legend” buttons.

DAW: A digital audio workstation that may be an electronic device or computer software application for recording, editing and producing audio files such as songs, musical pieces, film scores, human speech, sound effects, and the like.

GUI: Graphical User Interface. As used herein, “GUI” refers to the visual user interface design of a plug-in.

Instantiate: To call a Plug-in into service by loading the Plug-in into a DAW Track.

MIDI: A Musical Instrument Digital Interface that may be a technical standard that describes a communication protocol, digital interface, and connectors, and allows a wide variety of electronic musical instruments, computers and other related devices to connect and communicate with one another. MIDI may carry event messages that specify notation, pitch and velocity, control signals for parameters such as volume, vibrato, audio panning, cues, and clock signals that set and synchronize tempo between multiple devices. The messages may be sent via a MIDI cable to other devices where they control sound generation and other features. MIDI may also be emulated in a virtual environment, enabling communication between software components.

MIDI Controller: A MIDI controller may be any hardware or software that generates and transmits Musical Instrument Digital Interface (MIDI) data to electronic or digital MIDI-enabled devices, typically to trigger sounds and control parameters for an electronic music performance. The most commonly used MIDI controller is the electronic musical keyboard MIDI controller, which has piano-style keys that may be played like any keyboard instrument. When the keys are pressed, the MIDI controller sends MIDI data about the pitch of the note, the velocity and duration, which may be used to trigger sounds from a MIDI-compatible sound module or synthesizer. Many MIDI controllers also have knobs, sliders, buttons, and touch pads that provide tactile control for software parameters.

Parameter: A variable control in a music software interface whose setting may be changed by the end user to achieve a desired result. A given Plug-in may have one or more parameters, or up to over 1,000 depending on its depth and complexity.

Plug-in: Plug-ins may be software programs that are loaded within a DAW that greatly enhance the DAW's capabilities. They are typically divided into two groups, effects (signal processing) and virtual instruments (sound sources). Effects often emulate real-world hardware such as Equalizers, Compressors, Reverbs, and other hardware. They may be used in the same way as their hardware counterparts and often offer flexibility due to the nature of software. Virtual instruments are software-based plug-in instruments that may be played from within a DAW (and often standalone). A user may access realistic instrument sounds such as drums, piano, electronic keyboards, basses, orchestral instruments and more using virtual instruments. Virtual instruments give users access to instruments that they normally would not have access to due to budget or space constraints in their studio. Plug-ins may come in many different formats such as VST, VST3, RTAS, DXI, AAX, and Audio Units that allow them to function within a DAW. Every DAW is typically compatible with at least one of these formats.

Track: Digital audio tracks that let a user store audio data as digital sound recordings. A digital audio track works similarly to a tape machine. A user may record a musical performance on a single track using a virtual instrument, or record multiple instruments on multiple tracks and then mix them to create a complete musical work. Most DAWs are capable of recording hundreds of tracks in one project.

USB CDC: USB Communications Device Class is a composite Universal Serial Bus device class for enabling communication between devices connected via USB.

Wrapper: A software interface/layer that may be between instrument/effect plug-ins and the DAW. The wrapper creates a shell around the Plug-in and provides more options and capabilities for using the plug-in within the DAW. A Plug-in that is embedded within a wrapper is called a “wrapped plug-in”.

FIG. 1 is a diagram of one embodiment showing different components of TCS 100 and how the different components interact. As shown in FIG. 1, there may be three main components to TCS. First, a Control Surface 110 that may be capable of MIDI communication over USB or USB CDC communication. Second, a user-supplied DAW 105 that may contain plug-ins wrapped by a TCS Wrapper program. Third, a second software application 115, 120 that may allow the user to find, view and touch plug-in parameters in an ergonomic space physically close to the Control Surface 110.

FIG. 2 is a screenshot of one embodiment of a DAW 200 with an active plug-in. As shown in FIG. 2, the DAW 200 may comprise one or more channels 205, plug-ins 210, and a legend 220. The DAW 200 may run on a first electronic data processing device 202, such as a computer, and function analogously to a multi-track audio editing tool to allow a user to edit audio tracks within the DAW 200.

Plug-ins may be wrapped for use with the TCS within the DAW 200, and then assigned to specific tracks 205. Each of the tracks 205 may comprise an audio track and one or more plug-ins 210 may be assigned to the track 205. A user may select a specific track 205 in the DAW 200 by use of a standard computer interface device, such as a mouse. Once a track 205 is selected by the user, an assigned wrapped plug-in 210 may be opened and accessed within the DAW 200, which may then display a wrapped plug-in 210 interface to allow a user to edit the wrapped plug-in in the track 210 using digital audio editing tools 215 contained within the plug-in 210. The digital audio editing tools 215 may be a digital representative of various analog audio editing tools, and these digital audio editing tools 215 may be represented by digital input mechanisms, such as digital rotary knobs, digital push buttons, digital switches, digital touch sliders, digital toggles, and other digital input mechanisms.

The legend 220 may be a digital representation of a tactile control surface, described further hereinbelow in FIG. 6. In an alternative embodiment, the legend 220 may be a component of the wrapped plug-in 210. The digital representation of the tactile control surface may comprise one or more digital input mechanisms representing physical input mechanisms of the tactile control surface. The legend 220 may indicate to a user which functions of the plug-in 210 have been assigned to physical input mechanisms of the tactile control surface. In one embodiment, the digital audio editing tools 215 of the plug-in 210 may be assigned to physical input mechanisms of the tactile control surface, such that interacting with the physical input mechanisms cause the digital audio editing tools 215 of the plug-in 210 to be used. In one embodiment of the tactile control system, where a MIDI controller is not used, the assignments may be saved between uses of the plug-in 210, such that, where a plug-in 210 is closed and re-opened, or used in multiple tracks 205, each instance of the plug-in 210 retains its set of assigned control inputs of the tactile control surface.

For example, a plug-in 210 may comprise a digital audio editing tool in the form of a rotary knob that controls volume. A user may then assign the rotary knob that controls volume of the plug-in 210 to a physical rotary knob, or other physical input mechanism, of the tactile control surface. Once this assignment has been created, the user may utilize the physical rotary knob, or other physical input mechanism, of the tactile control surface to control the digital audio editing tool in the form of a rotary knob that controls volume. This assignment may also be displayed in the legend 220 alongside the digital input mechanism representing the physical rotary knob, or physical input mechanism, of the tactile control surface so that the user may quickly ascertain which physical input mechanisms of the tactile control surface are assigned to which digital audio editing tools 215 of the plug-in 210. Also displayed in the legend 220 alongside the digital input mechanism representing the physical rotary knob, or physical input mechanism, of the tactile control surface may be a numerical value to indicate the setting of the digital audio editing tool, such as the number 60 to indicate a value of volume of 60%, or other representative methods.

While digital and physical rotary knobs are used in the above example, additional digital and physical input mechanisms may be used, such as rotary knobs, push buttons, switches, touch sliders, toggles, and other input mechanisms. Furthermore, a user may assign non-corresponding digital input mechanisms to physical input mechanisms, such as assigning a digital rotary knob to a physical touch slider, if the user so wishes.

FIG. 3 is a screenshot 300 of one embodiment of a DAW with a plug-in selection pane. As shown in FIG. 3, the DAW 200 may comprise a list of wrapped plug-ins 305. Once a user has created a track 310, the user may select a specific plug-in from the list of plug-ins 305 and open that specific plug-in to the track. The list of plug-ins 305 may be based on plug-ins that were previously wrapped for use with the TCS system in the DAW 200.

FIG. 4 is a screenshot of one embodiment of a plug-in selection screen on a tablet 402. As shown in FIG. 4, the tablet selection screen 400 may comprise a list of tracks available in the DAW 405, 415, 425, as described hereinabove and wrapped plug-ins 410, 420, 430. The tablet may comprise a tablet application. The tablet 402 may be in electronic communication with the electronic data processing device 202 running the DAW 200. The first software application may transmit information to the tablet application over a network connection, such as information regarding the tracks 405, 415, 425, wrapped plug-ins 410, 420, 430, and other related settings. The tablet application may transmit information to the first software application, including user input related to wrapped plug-ins in tracks 205 in the DAW 200. The tablet and the electronic data processing device comprising the DAW 200 may be in electronic communication by wireless or other electronic communication methods. The tracks 205 in the DAW 200 may correspond to the tracks 405, 415, 425 listed in the plug-in selection screen 400, including related information such as the plug-ins in the tracks 205 of the DAW 200. Changes made to the tracks 405, 415, 425 or their wrapped plug-ins 410, 420, 430 on the tablet may be conveyed to the first software application, wherein the changes made to the channels 405, 415, 425 or their plug-ins 410, 420, 430 on the tablet may be reflected in the tracks 205 and wrapped plug-ins contained within the DAW 200.

In one embodiment, information may be displayed on the tablet, including the tracks and plug-ins, via a screen mirroring function of the DAW. Changes made to the tracks or plug-ins on the tablet may be transmitted to the DAW, and may be made to the tracks and wrapped plug-ins of the DAW.

Within the list of tracks 405, 415, 425 displayed, there may be a thumbnail preview of the plug-ins 410, 420, 430 that are contained within the track 405, 415, 425. The user may select one of the thumbnail previews of the plug-ins 410, 420, 430, such as by tapping in the case of a tablet, in order to open the plug-in on the tablet (See FIG. 5). The thumbnail previews may allow a user to quickly and easily select the desired plug-in 410, 420, 430 based on visual recollection. The thumbnail display also allows users to quickly and intuitively switch between plug-ins 410, 420, 430 for ease of editing audio contained within the respective tracks 405, 415, 425.

In an alternative embodiment, a different electronic data processing device may be used instead of a tablet, such as a phone, laptop, computer, or other electronic data processing device that is not running the DAW 200 directly.

FIG. 5 is a screenshot 500 of one embodiment of a selected plug-in on a tablet. As shown in FIG. 5, the tablet may display a selected plug-in 510. The selected plug-in 510 may comprise audio editing tools 515, a legend 520, and an option to return to the plug-in selection screen 530. The selected plug-in 510 may be selected through the plug-in selection screen 400 on the tablet 402, as described in FIG. 4. The user may interact with the selected plug-in 510 on the tablet, similar to how the user would interact with a plug-in in the DAW 200, and these interactions may be transmitted to the corresponding wrapped plug-in of the DAW 200.

In one embodiment, one possible procedure for assigning physical input mechanisms to digital audio editing tools comprises the steps: 1) actuate a learn physical input mechanism of the tactile control surface; 2) in the plug-in, either on the DAW or the tablet application, select the desired digital audio editing tool; 3) repeat step 2 until desired assignments are identified; and 4) actuate the learn physical input mechanism of the tactile control surface to end assignment procedure. In this embodiment, the physical input mechanisms assigned may be automatically assigned based on availability of the physical input mechanisms for assignment.

In an alternative embodiment, a procedure for assigning physical input mechanisms to digital audio editing tools may comprise the steps: 1) actuate a learn physical input mechanism of the tactile control surface; 2) in the plug-in, either on the DAW or the tablet application, select the desired digital audio editing tool; 3) select the desired physical input mechanism to be assigned to the selected digital audio editing tool; 4) repeat steps 2-3 until desired assignments are identified; and 5) actuate the learn physical input mechanism of the tactile control surface to end assignment procedure. In this embodiment, the physical input mechanisms assigned may be assigned based on the user's specific commands.

Once physical input mechanisms of the tactile control surface have been assigned to digital audio editing tools, the user may use the physical input mechanisms to use the audio editing tools. Additionally, because MIDI is bypassed in the assignment procedure, the assignment may be saved and automatically recalled at a later time for a given wrapped plug-in, whether the plug-in is used in the same track or a different track, or whether the plug-in is used in an entirely different session, project, or DAW.

FIG. 6 is an illustration of one embodiment of a tactile control surface 600. As shown in FIG. 6, the tactile control surface 600 may comprise a physical learn button 605, physical pre-set selector buttons 625, physical legend button 610, physical free wheel 615, physical rotary knobs 650, 655, 660, 665, 670, 675, 680, 685, physical push buttons 630, 635, 640, 645, and physical touch fader 620. The physical rotary knobs 650, 655, 660, 665, 670, 675, 680, 685, physical push buttons 630, 635, 640, 645, and physical touch fader 620 may be assigned to various audio editing tools as explained in FIG. 5. Alternatively, the tactile control surface 600 may comprise any other physical input mechanisms. The free wheel 615 may remain unassigned, and be used with an active or selected audio editing tool.

The tactile control surface 600 may be connected via wire to the electronic data processing device comprising the DAW 200. In one embodiment, the tactile control surface 600 is connected to the first electronic data processing device via universal serial bus.

FIG. 7 is a flow diagram 700 showing interactions between components of one embodiment of the tactile control system. As shown in FIG. 7, the tactile control system may comprise various electronic interactions. Electronic interactions depicted in solid lines in FIG. 7 are direct electronic connections, whereas electronic interactions depicted in dashed lines in FIG. 7 are virtual, implicit, or indirect electronic connections.

A PluginOrganizer-Hardware Controller connection 1 allows information to be sent to a PluginOrganizer when a Hardware Controller, also referred to herein as a tactile control surface or controller, is manipulated or used by a user. This information may include control states, control functions, and controller illumination. The PluginOrganizer may function as a brain of the controller. A PluginOrganizer-NetService connection 2 allows a NetService to manage communication between a tablet, tablet software, and the PluginOrganizer. A NetService-Tablet Software connection 3 allows bi-directional communication between the PluginOrganizer and the Tablet Software.

A wireless viewing connection 4 allows the plug-in to be displayed on the tablet, through TCP/WiFi connections. Edits made on the plug-in using tablet controls may be sent to the PluginOrganizer. Depending on the operating systems used, there may be numerous wireless viewing interactions.

A thumbnail viewing connection 5 may allow the various plug-ins available in tracks of a DAW to be displayed in thumbnail view on the tablet. Tablet software may query the PluginOrganizer, display thumbnails of active plugins and send plugin selection information back to the PluginOrganizer.

A wired viewing connection 6 may function substantially similarly to a combination of the wireless viewing connection 4 and the thumbnail viewing interaction 5, with the primary difference being that the connection is wired, such as through USB, which limits the number of available connections, such as a single connection.

A tablet-NetService connection 7 may allow bi-directional communication between the PluginOrganizer and the tablet. A browsing services connection 8 may allow a tablet connected to the NetService via a wireless, or TCP/WiFi, connection to select a desired computer or DAW with which to connect. This browsing services connection 8 may not be required when the tablet is connected via USB.

A plugin nesting connection 9 may allow plugins to be nested in wrappers, or wrapped. An attachment connection 10 may allow wrapped plugins to be connected or disconnected from the PluginOrganizer. A PluginOrganizer-plugin connection 11 may allow a wrapped plugin to send and receive communications with the PluginOrganizer. Data sent from the PluginOrganizer to the wrapped plugin may allow a graphical user interface to be updated based on user input.

A ScreenService-plugin connection 12 may allow data to be transferred between the plugin and ScreenService, thereby allowing graphical user interface data to be synced, wherein changes made to the plugin on either the DAW or tablet are reflected in the other. The ScreenService-PluginOrganizer 13 connection ensures all wrapped plugins are updated at all times.

A tablet software-plugin connection 14 may allow for edits made on the tablet to be updated in the plugin, and vice versa. Similarly, a tablet thumbnail-plugin connection 15 may allow thumbnails of the plug-in selection screen of the tablet to be updated.

A hardware controller-plugin connection 16 may allow the hardware controller to send input values to the plugin. A hardware controller-tablet software connection 17 may allow the hardware controller to send information to the tablet software indicating that the hardware controller is active and able to send and receive information.

In a preferred embodiment, the PluginOrganizer, NetService, wrapped plugin, plugin GUI, and ScreenService may all be located on a first electronic data processing device, as described hereinabove. The tablet and hardware controller may be separate devices.

The foregoing description of the preferred embodiment has been presented for the purposes of illustration and description. While multiple embodiments are disclosed, still other embodiments will become apparent to those skilled in the art from the above detailed description. The disclosed embodiments are capable of modifications in various obvious aspects, all without departing from the spirit and scope of the protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope. It is intended that the scope or protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A touch control interface system comprising:
a first electronic data processing device;
a second electronic data processing device; and
a tactile control surface;
wherein said first electronic data processing device comprises an input device and first electronic data processing device display;
wherein said first electronic data processing device comprises a first software application;
wherein said first electronic data processing device comprises a digital audio workstation;
wherein one or more audio plug-ins are wrapped in said digital audio workstation, such that said one or more audio plug-ins are accessible via use of said digital audio workstation;
wherein said one or more plug-ins comprise signal processors or sound sources for audio tracks;
wherein said one or more plug-ins comprise an audio editing software interface for editing said plug-ins;
wherein said audio editing software interface comprises digital representations of analog audio editing controls;
wherein said second electronic data processing device comprises a second software application and second electronic data processing device display;
wherein said second software application is in electronic communication with said digital audio workstation;
wherein said second software application is in electronic communication with said one or more audio plug-ins;
wherein said tactile control surface is in electronic communication with said digital audio workstation;
wherein said tactile control surface is in electronic communication with said one or more audio plug-ins;
wherein said second software application displays said one or more audio plug-ins on a display of said second electronic data processing device;
wherein said second software application allows for selection of said one or more audio plug-ins via said second electronic data processing device;
wherein selecting said one or more audio plug-ins on said second electronic data processing device displays said one or more audio plug-ins;
wherein said tactile control surface comprises physical input mechanisms;
wherein said physical input mechanisms comprise assignable tactile interfaces; and
wherein one or more of said physical input mechanisms are configured to be assignable to portions of said digital representations of analog audio editing controls.

2. The touch control interface system of claim 1, wherein said physical input mechanisms comprise rotary knobs, push buttons, switches, and touch sliders.

3. The touch control interface system of claim 2, wherein said tactile control surface comprises a free wheel.

4. The touch control interface system of claim 3, wherein said input mechanisms comprise a learn mechanism.

5. The touch control interface system of claim 4, wherein one or more of said physical input mechanisms are configured to be assignable to portions of said digital representations of analog audio editing controls through use of said learn mechanism.

6. The touch control interface system of claim 5, wherein said physical input mechanisms comprise indicators that said one or more of said physical input mechanisms are assigned to portions of said digital representations of analog audio editing controls.

7. The touch control interface system of claim 5, wherein said assignments of said physical input mechanisms to digital representations of analog audio editing controls are saved to a profile and are loadable when said one or more audio plugins are active.

8. The touch control interface system of claim 7, wherein said tactile control surface is not connected to said digital audio workstation via a MIDI controller protocol.

9. The touch control interface system of claim 1, wherein said second electronic data processing device is a tablet.

10. The touch control interface system of claim 1, wherein said second electronic data processing device display is located near said tactile control surface.

11. The touch control interface system of claim 1, wherein said tactile control surface is in electronic communication with said digital audio workstation via a wired connection.

12. The touch control interface system of claim 1, wherein said digital representation of an analog audio editing tool displayed on said second electronic data processing device is similar in appearance to said physical input mechanism.

13. A method of editing digital audio, the steps comprising:
providing a tactile control surface;
providing a first software application configured to run on a first electronic data processing device;
providing a second software application configured to run on a second electronic data processing device;
wherein said first software application is in communication with a digital audio workstation and said one or more wrapped plug-ins;
wherein said second software application is in electronic communication with said digital audio workstation and said one or more wrapped plug-ins;
wherein said tactile control surface is in electronic communication with said first software application;
engaging a learn function by pressing a physical learn button of said tactile control surface;
selecting a digital representation of an analog audio editing tool displayed on said second electronic data processing device;
assigning a physical input mechanism to said selected digital representation of an analog audio editing tool; and
disengaging said learn function by pressing said physical learn button of said tactile control surface.

14. A touch control interface system comprising:
a first electronic data processing device;
a second electronic data processing device; and
a tactile control surface;
wherein said first electronic data processing device comprises an input device and first electronic data processing device display;
wherein said first electronic data processing device comprises a first software application;
wherein said first electronic data processing device comprises a digital audio workstation;
wherein one or more audio plug-ins are wrapped in said digital audio workstation, such that said one or more audio plug-ins are accessible via use of said digital audio workstation;
wherein said one or more plug-ins comprise signal processors or sound sources for audio tracks;
wherein said one or more plug-ins comprise an audio editing software interface for editing said plug-ins;
wherein said audio editing software interface comprises digital representations of analog audio editing controls;
wherein said second electronic data processing device comprises a second software application and second electronic data processing device display;
wherein said second software application is in electronic communication with said digital audio workstation;
wherein said second software application is in electronic communication with said one or more audio plug-ins;
wherein said tactile control surface is in electronic communication with said digital audio workstation;
wherein said tactile control surface is in electronic communication with said one or more audio plug-ins;
wherein said second software application displays said one or more audio plug-ins on a display of said second electronic data processing device;
wherein said second software application allows for selection of said one or more audio plug-ins via said second electronic data processing device;
wherein selecting said one or more audio plug-ins on said second electronic data processing device displays said one or more audio plug-ins;
wherein said tactile control surface comprises physical input mechanisms;
wherein said physical input mechanisms comprise assignable tactile interfaces;
wherein one or more of said physical input mechanisms are configured to be assignable to portions of said digital representations of analog audio mixing controls;
wherein said physical input mechanisms comprise rotary knobs, push buttons, switches, and touch sliders;
wherein said tactile control surface comprises a free wheel;
wherein said input mechanisms comprise a learn mechanism;
wherein one or more of said physical input mechanisms are configured to be assignable to portions of said digital representations of analog audio editing controls through use of said learn mechanism;
wherein said physical input mechanisms comprise indicators that said one or more of said physical input mechanisms are assigned to portions of said digital representations of analog audio editing controls;
wherein said assignments of said physical input mechanisms to digital representations of analog audio editing controls are saved to a profile and are loadable when said one or more audio plugins are active;
wherein said second electronic data processing device is a tablet;
wherein said second electronic data processing device display is located near said tactile control surface;
wherein said tactile control surface is in electronic communication with said digital audio workstation via a wireless connection; and
wherein said tactile control surface is in electronic communication with said digital audio workstation via a wired connection.
